(19) United States
(12) Patent Application Publication
(10) Pub. No.: US 2010/0124729 A1
(43) Pub. Date: May 20, 2010

(54) Toothbrush with water delivery and suction unit

(76) Inventors: Yu-Mei Liao, Kaohsiung (TW); Fan-Hao Chou, Kaohsiung (TW)

Correspondence Address: JACOBSON HOLMAN PLLC, 400 SEVENTH STREET N.W., SUITE 600, WASHINGTON, DC, 20004, US

(21) Appl. No.: 12/591,059

(22) Filed: Nov. 5, 2009

Related U.S. Application Data
(63) Continuation-in-part of application No. 11/651,597, filed on Jan. 10, 2007, now abandoned.

(51) Int. Cl. A61C 17/22; A61C 17/06

(52) U.S. Cl. 433/80; 433/91

(57) ABSTRACT

A toothbrush includes: a hollow head portion defining a first fluid passage therein and having a bristle-mounting wall formed with a plurality of apertures in fluid communication with the first fluid passage; bristle bundles provided on the bristle-mounting wall, each of the bristle bundles being composed of a plurality of hollow bristles, each of the hollow bristles having a third fluid passage that has a connecting end in fluid communication with the first fluid passage and an open free end opposite to the connecting end; a hollow grip portion connected to the head portion and defining a second fluid passage therein, the second fluid passage being in fluid communication with the first fluid passage; and a suction unit connected to the grip portion and adapted to draw a fluid from an exterior of the bristle-mounting wall through the apertures and the third fluid passages.

### CROSS-REFERENCE TO RELATED APPLICATION

This application is a continuation-in-part (CIP) of U.S. patent application Ser. No. 11/651,597, filed on Jan. 10, 2007, the entire disclosure of which is incorporated herein by reference.

### BACKGROUND OF THE INVENTION

1. Field of the Invention

This invention relates to a toothbrush, more particularly to a toothbrush including a suction unit and hollow bristles, which can be used to draw fluids from a user's mouth.

2. Description of the Related Art

A patient, who loses regular oral activity, such as opening/closing of the mouth, swallowing, spitting action, etc., normally needs an assistant to do oral cleaning, e.g., brushing of teeth. Since the patient cannot spit the fluids produced during oral cleaning, suffocation is likely to occur. To prevent suffocation, the fluids have to be removed during oral cleaning. However, it is relatively difficult and inconvenient for the assistant to substantially remove the fluids from the patient's mouth during brushing of teeth.

Therefore, there is a need in the art to provide a toothbrush that includes a suction unit and hollow bristles for drawing the fluids from the patient's mouth during oral cleaning, e.g., brushing of teeth.

### SUMMARY OF THE INVENTION

According to this invention, a toothbrush includes a hollow head portion defining a first fluid passage therein and having a bristle-mounting wall formed with a plurality of apertures in fluid communication with the first fluid passage; bristle bundles provided on the bristle-mounting wall of the head portion, each of the bristle bundles being composed of a plurality of hollow bristles, each of the hollow bristles having a third fluid passage that has a connecting end in fluid communication with the first fluid passage and an open free end opposite to the connecting end; a hollow grip portion connected to the head portion and defining a second fluid passage therein, the second fluid passage being in fluid communication with the first fluid passage; and a suction unit connected to the grip portion and adapted to draw a fluid from an exterior of the bristle-mounting wall of the hollow head portion through the apertures and the third fluid passages of the bristle bundles.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary exploded perspective view of the first preferred embodiment of a toothbrush according to this invention;

FIG. 2 is a fragmentary schematic partly sectional view of the first preferred embodiment, illustrating how a suction action is conducted;

FIG. 3 is a fragmentary schematic partly sectional view of the first preferred embodiment, illustrating the arrangement of a hollow head portion, apertures, and bristle bundles;

FIG. 4 is a fragmentary schematic partly sectional view of the first preferred embodiment, illustrating the cleaning operation of the bristle bundles during oral cleaning; and

FIG. 5 is a fragmentary schematic partly sectional view of the second preferred embodiment of the toothbrush according to this invention.

### DETAILED DESCRIPTION OF THE PREFERRED EMBODIMENTS

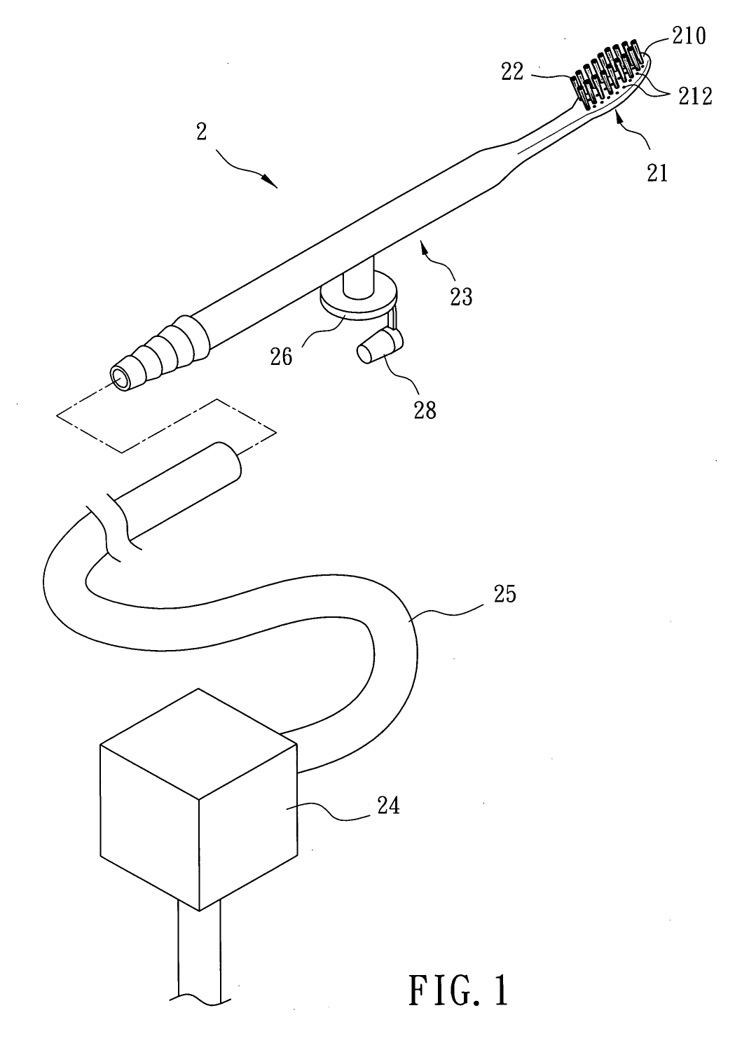

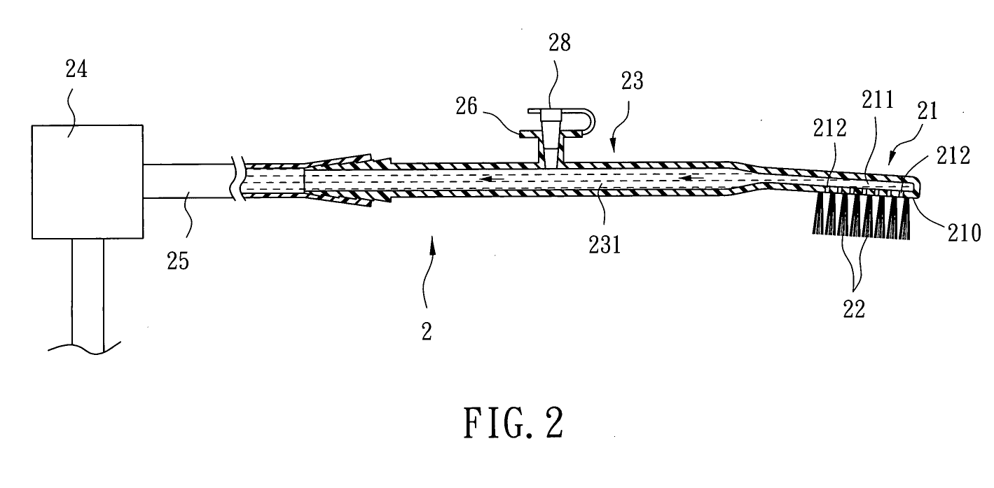

Referring to FIGS. 1 and 2, the first preferred embodiment of a toothbrush 2 according to the present invention is shown to include a hollow head portion 21, bristle bundles 22, a hollow grip portion 23, and a suction unit 24.

The hollow head portion 21 defines a first fluid passage 211 therein and has a bristle-mounting wall 210 formed with a plurality of apertures 212 in fluid communication with the first fluid passage 211.

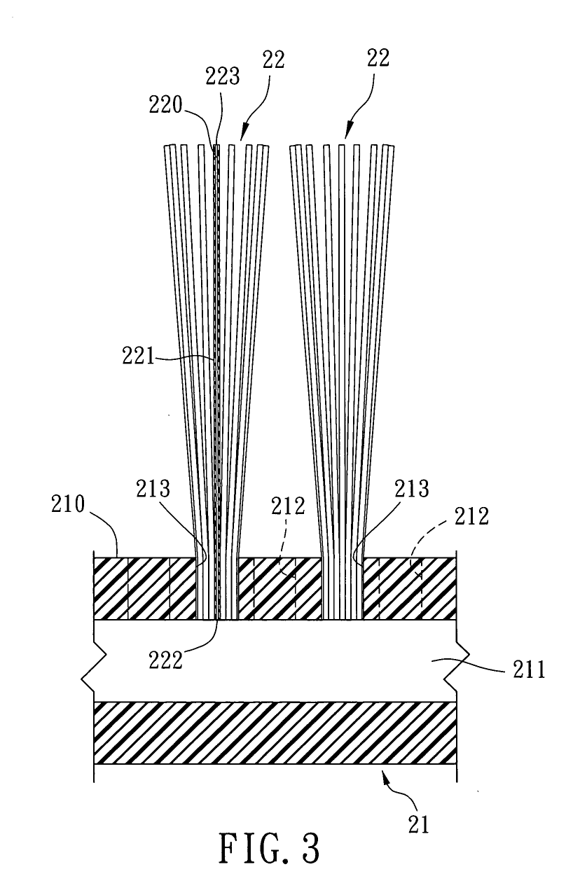

As shown in FIG. 3, the bristle bundles 22 are respectively fitted in mounting holes 213 provided in the bristle-mounting wall 210 of the hollow head portion 21 and are offset from the apertures 212. Preferably, each of the apertures 212 is disposed between two adjacent ones of the mounting holes 213 or the bristle bundles 22. Each of the bristle bundles 22 is composed of a plurality of hollow bristles 221. Each of the hollow bristles 221 has a third fluid passage 220 that has a connecting end 222 in fluid communication with the first fluid passage 211 and an open free end 223 opposite to the connecting end 222. Fluids (e.g., waste fluids) can flow into the third passage 220 from a user's mouth through the open free end 223, and then flow into the first fluid passage 211 through the connecting end 222.

As shown in FIG. 2, the hollow grip portion 23 is connected to the hollow head portion 21 and defines a second fluid passage 231 therein. The second fluid passage 231 is in fluid communication with the first fluid passage 211. The suction unit 24 is connected to the hollow grip portion 23, and is adapted to draw a waste fluid from the user's mouth through the apertures 212 and/or the third fluid passages 220 and through the first and second fluid passages 211, 231.

Preferably, the hollow grip portion 23 is formed with an air inlet 26 in fluid communication with the second fluid passage 231 and the atmosphere (see FIG. 2). The toothbrush 2 further includes a cover 28 provided on the grip portion 23 for covering and uncovering the air inlet 26 and for controlling a suction pressure produced by the suction unit 24 in the second fluid passage 231 for the waste fluid. Specifically, when it is necessary to withdraw a waste fluid produced in the user's mouth during brushing of teeth, the air inlet 26 should be covered by the cover 28 so that the second fluid passage 231 is closed and the suction unit 24 can produce a suction pressure in the second fluid passage 231, thereby suctioning the waste fluid from the user's mouth into the second fluid passages 231, through the apertures 212, the hollow bristles 221, and the first fluid passage 211.

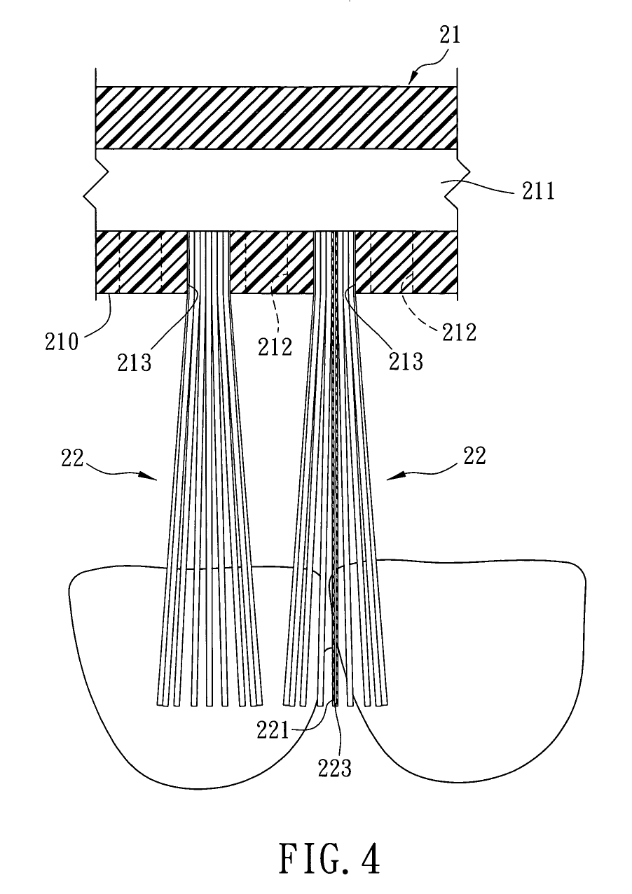

Referring to FIG. 4, during the suctioning operation, the hollow bristles 221 can be used to draw residual waste fluid trapped in the mouth where the apertures 212 cannot reach, e.g., the spaces between the teeth and the space below the tongue, because the hollow bristles 221 can extend into those spaces. With the use of the hollow bristles 221, the waste fluid can be effectively drawn away from the mouth. When the waste fluid is substantially removed, the cover 28 covering the air inlet 26 can be removed from the air inlet 26 so that no suction pressure is produced for the waste fluid in the second fluid passage 231.

Preferably, the cover 28 can be a plug, a knob, etc.

The toothbrush 2 may further include a tube 25 for interconnecting the hollow grip portion 23 and the suction unit 24 (see FIG. 1). The suction unit 24 can be any kind of pump suitable for achieving the object of this invention.

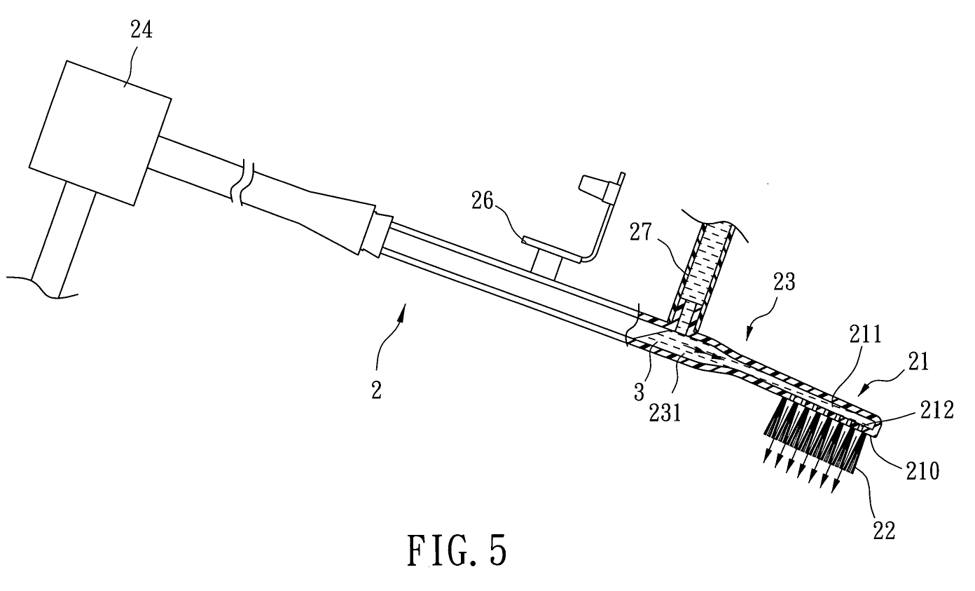

FIG. 5 illustrates the second preferred embodiment of the toothbrush 2 according to this invention. This preferred embodiment differs from the previous embodiment in that the hollow grip portion 23 is further formed with a water inlet 27 disposed at a location between the air inlet 26 and the hollow head portion 21 and in fluid communication with the second fluid passage 231. When a clean fluid 3 is to be injected into the user's mouth through the water inlet 27 for rinsing or cleaning purpose, the air inlet 26 has to be opened so as to prevent the clean fluid 3 from being withdrawn by the suction unit 24. Moreover, the toothbrush 2 has to be disposed at a tilted position, i.e., the hollow grip portion 23 is disposed higher than the hollow head portion 21 so that the clean fluid 3 can flow into the user's mouth from the water inlet 27 through the second fluid passage 231, the first fluid passage 211, and the apertures 212 and the hollow bristles 221.

With the inclusion of the hollow bristles 221 provided with the third fluid passage 220 and the suction unit 24 in the toothbrush 2 of this invention, brushing of teeth and removal of mouth fluids can be easily and simultaneously carried out by an assistant (i.e., operator) and the fluid can be substantially removed from the mouth so as to improve cleaning efficiency and to prevent suffocation caused by the fluids produced during brushing of teeth.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A toothbrush comprising:
a hollow head portion defining a first fluid passage therein and having a bristle-mounting wall formed with a plurality of apertures in fluid communication with said first fluid passage;
bristle bundles provided on said bristle-mounting wall of said head portion, each of said bristle bundles being composed of a plurality of hollow bristles, each of said hollow bristles having a third fluid passage that has a connecting end in fluid communication with said first fluid passage and an open free end opposite to said connecting end;
a hollow grip portion connected to said head portion and defining a second fluid passage therein, said second fluid passage being in fluid communication with said first fluid passage; and
a suction unit connected to said grip portion and adapted to draw a fluid from an exterior of said bristle-mounting wall of said hollow head portion through said apertures and said third fluid passages of said bristle bundles.

2. The toothbrush of claim 1, wherein said hollow grip portion is formed with an air inlet in fluid communication with said second fluid passage and the atmosphere, said toothbrush further comprising a cover provided on said grip portion for covering and uncovering said air inlet.

3. The toothbrush of claim 2, wherein said hollow grip portion is formed with a water inlet disposed at a location between said air inlet and said hollow head portion, in fluid communication with said second fluid passage, and adapted to receive water therein.

4. The toothbrush of claim 1, wherein each of said apertures is disposed between two adjacent ones of said bristle bundles.
